(19) United States
(12) Patent Application Publication
(10) Pub. No.: US 2012/0270624 A1
(43) Pub. Date: Oct. 25, 2012

(54) Card deck and card game

(76) Inventor: William GRAY, Ottawa (CA)

(21) Appl. No.: 13/308,091

(22) Filed: Nov. 30, 2011

Related U.S. Application Data
(60) Provisional application No. 61/477,898, filed on Apr. 21, 2011.

(51) Int. Cl. G06F 17/00; A63F 7/02; G09F 7/00; A63F 1/00

(52) U.S. Cl. 463/13; 273/303; 273/119 R; 40/584

(57) ABSTRACT

Disclosed is a composite deck of 100 playing cards. The composite deck includes five identical sets of cards, each set including the five highest ranked cards of 10, Jack, Queen, King and Ace in four different suits, preferably each of the four suits of Diamonds, Clubs, Hearts and Spades. The composite deck includes five equal cards of each value and suit, which, when the deck is used in a Poker game, significantly increases the number of possible winning hands compared to any other deck used in conventional Poker games. It is a further advantage of the composite deck of the invention that unique and new winning hands are achievable, in particular winning hands with 5 cards of equal value, most importantly winning hands with 5 cards of equal value and/or suit. In a variant of the composite deck, at least one card is replaced with a Joker card.

### CROSS REFERENCE TO RELATED APPLICATIONS

This application claims the benefit of priority of U.S. Provisional Patent Application No. 61/477,898 filed Apr. 24, 2011, the contents of which is incorporated herein by reference.

### FIELD

The present disclosure relates generally to card games and card decks. More particularly, the present disclosure relates to poker type games and card decks.

### BACKGROUND

A conventional 52-card deck is commonly used in playing poker games. However, the number of winning hands is limited, in particular when a larger number of players participate in the game. The more players are in the game, the lower the number of high ranking winning hands obtainable, which makes the game progressively more boring with each added player.

To increase the chances of obtaining a high ranking winning hand and, thus, raise the excitement level of the game, the use of a twenty-card deck is disclosed in U.S. Pat. No. 7,469,900, which deck includes only the five highest ranked cards in each of the four suits. However, this 20 card deck can only be used to achieve the 10 winning poker hands as illustrated in FIG. 1.

Texas Hold'Em is a poker variant intended to involve up to nine players. In Texas Hold'Em, a standard 52-card deck is used, making the game rather boring since many of the winning hands experienced during play are of low value only. Moreover, Texas Hold'Em cannot be played with a 20 card deck, unless the number of players is limited to six. In Texas Hold'Em, each player receives 2 cards. With six players, five community cards and three burn cards, all twenty cards of the twenty-card deck are utilized. Thus, although the use of a twenty-card deck might make a game of Texas Hold'Em more exciting than if a standard 52-card deck is used, the significant disadvantage is the reduced number of players.

Consequently, it would be desirable to find an improved card deck and an improved manner of playing a poker game which overcomes at least one of the above disadvantages

### SUMMARY

It is an object of the present disclosure to obviate or mitigate at least one of the above discussed disadvantages of known poker games.

In a first aspect, the present disclosure provides a composite deck of 100 playing cards.

In a further aspect, there is provided a composite deck which includes five identical sets of cards, each set including the five highest ranked cards of 10, Jack, Queen, King and Ace in four different suits, preferably each of the four suits of Diamonds, Clubs, Hearts and Spades.

The composite deck includes five equal cards of each value and suit, which significantly increases the number of possible winning hands compared to any other deck used in conventional poker games. It is a further advantage of the composite deck of the invention that winning hands with 5 cards of equal value are possible for the first time, as are winning hands with 5 cards of equal value and suit.

In another aspect of the composite deck, at least one and up to five cards of the deck are replaced with a Joker card.

In a further aspect, the present disclosure provides a pinball machine with a playing field and scoring elements on the playing field representing different amounts of winning points, wherein at least one of the scoring elements is labeled on the playing field by a representation of a winning Poker hand selected from the group of Five Of A Kind Flush, Five Of A Kind 4 Flush One Off Suit, Five Of A Kind Three Flush Two Flush, Five Of A Kind Three Flush Two Off Suit, Five Of A Kind Two Flush Pairs One Off Suit, and Five Of A Kind One Flush Pair Three Off Suit. Preferably, the scoring element representing the highest amount of winning points is labeled on the playing field with the hand of Five Of A Kind Flush.

In yet another aspect, the present disclosure provides a video poker gaming machine, including a processor for creating random poker hands obtainable with the composite deck of cards of the present disclosure, a display for illustrating a respective poker hand created by the processor and a pay table including payouts for at least one winning hand selected from the group of Five Of A Kind Flush, Five Of A Kind 4 Flush One Off Suit, Five Of A Kind Three Flush Two Flush, Five Of A Kind Three Flush Two Off Suit, Five Of A Kind Two Flush Pairs One Off Suit, and Five Of A Kind One Flush Pair Three Off Suit. Preferably, the pay table includes at least one additional payout for at least one winning hand selected from the group of One Flush Pair, Two Flush Pairs, Two Pair One Flush One Off Suit, Three Of A Kind Flush, and Three Of A Kind Two Flush One Off Suit, Straight Four Flush, Straight Three Flush Two Flush, Straight Three Flush, Straight Two Flush Pairs, Straight Two Flush, Flush Three Of A Kind, Flush Two Pair, Flush One Pair, Full House Five Flush, Three Of A Kind Flush With Off Suit Flush Pair, Three Of A Kind Flush With Off Suit Pair, Three Of A Kind Two Flush One Off Suit With Flush Pair, Three Of A Kind Two Flush One Off Suit With Off Suit Pair, Three Of A Kind Off Suit With Flush Pair, Four Of A Kind Five Flush, Four Of A Kind Flush, Four Of A Kind Three Flush One Off Suit, Four Of A Kind Two Flush Pair, Four Of A Kind One Flush Pair One Off Suit Pair.

In still a further aspect, the present disclosure provides a method of operating a video poker gaming machine, including the steps of providing a pay table with six top level bonus amounts, and assigning each top level bonus amount to a different winning hand selected from the group of Five Of A Kind Flush, Five Of A Kind 4 Flush One Off Suit, Five Of A Kind Three Flush Two Flush, Five Of A Kind Three Flush Two Off Suit, Five Of A Kind Two Flush Pairs One Off Suit, and Five Of A Kind One Flush Pair Three Off Suit. Preferably, the method includes the further steps of including in the pay table at least one secondary bonus amount of lesser value than the top level bonus amounts and assigning the secondary bonus amount to at least one hand selected from the group of One Flush Pair, Two Flush Pairs, Two Pair One Flush One Off Suit, Three Of A Kind Flush, Three Of A Kind Two Flush One Off Suit, Straight Four Flush, Straight Three Flush Two Flush, Straight Three Flush, Straight Two Flush Pairs, Straight Two Flush, Flush Three Of A Kind, Flush Two Pair, Flush One Pair, Full House Five Flush, Three Of A Kind Flush With Off Suit Flush Pair, Three Of A Kind Flush With Off Suit Pair, Three Of A Kind Two Flush One Off Suit With Flush Pair, Three Of A Kind Two Flush One Off Suit With Off Suit Pair, Three Of A Kind Off Suit With Flush Pair, Four Of A Kind Five Flush, Four Of A Kind Flush, Four Of A Kind Three Flush One Off Suit, Four Of A Kind Two Flush Pair, and Four Of A Kind One Flush Pair One Off Suit Pair. Preferably, the method includes the further steps of including in the pay table at least 24 graduated secondary bonus amounts of lesser value than the top level bonus amounts and assigning each secondary bonus amount to a different winning hand selected from the group of One Flush Pair, Two Flush Pairs, Two Pair One Flush One Off Suit, Three Of A Kind Flush, Three Of A Kind Two Flush One Off Suit, Straight Four Flush, Straight Three Flush Two Flush, Straight Three Flush, Straight Two Flush Pairs, Straight Two Flush, Flush Three Of A Kind, Flush Two Pair, Flush One Pair, Full House Five Flush, Three Of A Kind Flush With Off Suit Flush Pair, Three Of A Kind Flush With Off Suit Pair, Three Of A Kind Two Flush One Off Suit With Flush Pair, Three Of A Kind Two Flush One Off Suit With Off Suit Pair, Three Of A Kind Off Suit With Flush Pair, Four Of A Kind Five Flush, Four Of A Kind Flush, Four Of A Kind Three Flush One Off Suit, Four Of A Kind Two Flush Pair, and Four Of A Kind One Flush Pair One Off Suit Pair.

In yet another aspect, the present disclosure provides an illustration, poster or display, including an illustration surface and on the illustration surface representations of at least one winning hand obtainable with the composite deck of the present disclosure. Preferably, the representations are of the winning hands of Five Of A Kind, namely Five Of A Kind Flush, Five Of A Kind 4 Flush One Off Suit, Five Of A Kind Three Flush Two Flush, Five Of A Kind Three Flush Two Off Suit, Five Of A Kind Two Flush Pairs One Off Suit, and Five Of A Kind One Flush Pair Three Off Suit. More preferably, the representations are of the winning hands of Five Of A Kind, namely Five Of A Kind Flush, Five Of A Kind 4 Flush One Off Suit, Five Of A Kind Three Flush Two Flush, Five Of A Kind Three Flush Two Off Suit, Five Of A Kind Two Flush Pairs One Off Suit, Five Of A Kind One Flush Pair Three Off Suit, One Flush Pair, Two Flush Pairs, Two Pair One Flush One Off Suit, Three Of A Kind Flush, Three Of A Kind Two Flush One Off Suit, Straight Four Flush, Straight Three Flush Two Flush, Straight Three Flush, Straight Two Flush Pairs, Straight Two Flush, Flush Three Of A Kind, Flush Two Pair, Flush One Pair, Full House Five Flush, Three Of A Kind Flush With Off Suit Flush Pair, Three Of A Kind Flush With Off Suit Pair, Three Of A Kind Two Flush One Off Suit With Flush Pair, Three Of A Kind Two Flush One Off Suit With Off Suit Pair, Three Of A Kind Off Suit With Flush Pair, Four Of A Kind Five Flush, Four Of A Kind Flush, Four Of A Kind Three Flush One Off Suit, Four Of A Kind Two Flush Pair, and Four Of A Kind One Flush Pair One Off Suit Pair.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a schematic representation of the winning poker hands achievable with a conventional 52 card deck;

FIG. 2 is a schematic representation of the winning poker hand achievable with the composite deck of the invention compared to the Ace High hand of a conventional twenty-card deck;

FIG. 3 is a schematic representation of the expanded winning poker hands achievable with the composite deck of the invention compared to the One Pair hand of a conventional twenty-card deck;

FIG. 4 is a schematic representation of the expanded winning poker hands achievable with the composite deck of the invention compared to the Two Pair hand of a conventional twenty-card deck;

FIG. 5 is a schematic representation of the expanded winning poker hands achievable with the composite deck of the invention compared to the Three Of A Kind hand of a conventional twenty-card deck;

FIG. 6 is a schematic representation of the expanded winning poker hands achievable with the composite deck of the invention compared to the Straight hand of a conventional twenty-card deck;

FIG. 7 is a schematic representation of the expanded winning poker hands achievable with the composite deck of the invention compared to the Flush hand of a conventional twenty-card deck;

FIG. 8 is a schematic representation of the expanded winning poker hands achievable with the composite deck of the invention compared to the Full House hand of a conventional twenty-card deck;

FIG. 9 is a schematic representation of the expanded winning poker hands achievable with the composite deck of the invention compared to the Four Of A Kind hand of a conventional twenty-card deck;

FIG. 10 is a schematic representation of the winning poker hand achievable with the composite deck of the invention compared to the Straight Flush of a conventional twenty-card deck;

FIG. 11 is a schematic representation of the winning poker hand achievable with the composite deck of the invention compared to the Royal Flush of a conventional twenty-card deck; and

FIG. 12 is a schematic representation of the completely new winning poker hands of Five Of A Kind, achievable with the composite deck of the invention and which have no comparator in a conventional twenty-card deck.

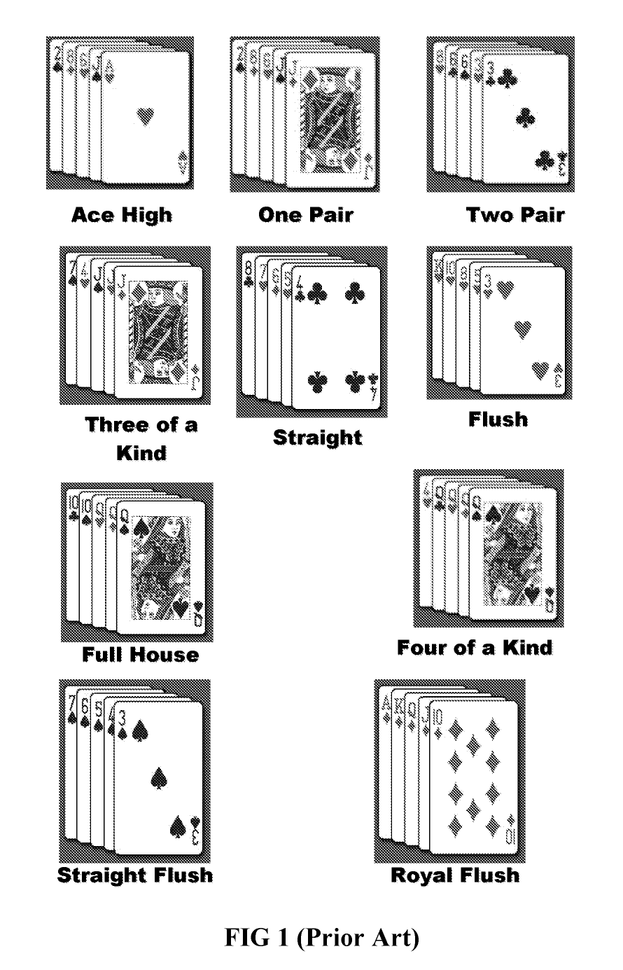

### DETAILED DESCRIPTION

Generally, the present disclosure provides a method and system for playing poker, using a composite deck of 100 playing cards, preferably consisting of five identical sets of twenty cards.

Conventional 52-card and twenty-card decks pose certain significant limitations on the manner a poker game is played, as discussed above. In particular, the level of excitement, which can be generated with a 52-card deck is average and, although the use of a twenty-card deck can raise the excitement level, the number of possible players is in turn significantly reduced, compared to a 52 card deck.

These problems are now addressed with the new composite deck of the invention. The composite deck not only allows for a simultaneous participation of nine players, or more, but raises the level of excitement of the game by providing far many more high ranking winning hands than any conventional card deck, as well as new winning hands previously not possible in the game of Poker, when played with a conventional card deck. Moreover, not only does the composite deck of the invention allow for a larger number of winning hands, it also reduces the chance of a games ending in a draw.

Although a twenty-card deck enables players to more frequently achieve rare poker hands, such as a royal flush, the chances are still quite low, making the game somewhat lacking in excitement.

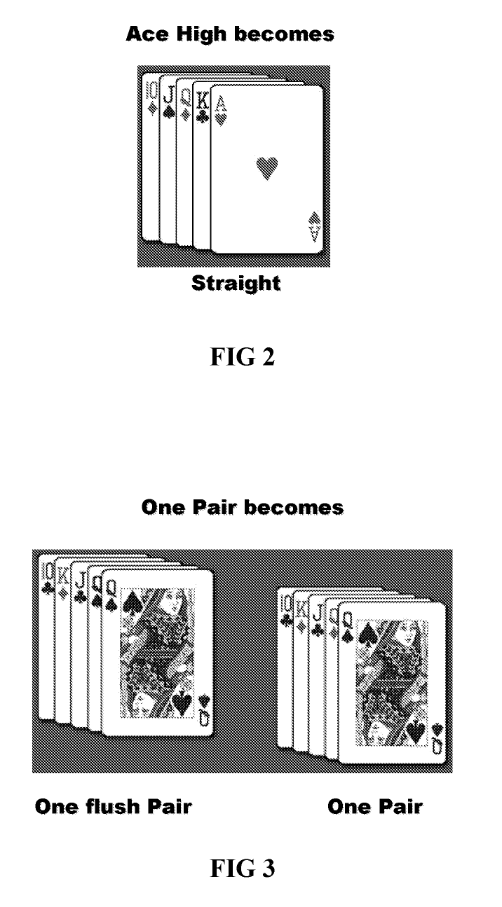

Compared to the conventional 20 card deck, the number of possible winning hands and, thus, the level of excitement associated with playing the game is significantly increased when the new composite deck of the invention is used, since the number of winning hands is in fact multiplied. The standard 20 card deck allows for only 10 possible winning hands. The number of possible winning hands jumps to 38 with the composite deck of the invention as illustrated in FIGS. 2 to 12. The combination of a much higher number of winning hands and the use of only the five highest ranked cards makes the occurrence of a highly ranked, and thus exciting, winning hand much more likely than with a standard 52-card deck, or even a twenty-card deck. Moreover, not only does the composite deck of the invention provide for a larger number of winning hands, it provides for groups of winning hands never before possible with standard 52-card or twenty-card decks. In fact, the new winning hand of “Five Of A Kind” was never before possible with standard decks. Of course, this allows for new highest rank winning hands, which will outrank any winning hand previously possible with conventional card decks. The highest winning hand in standard decks is the royal flush. The composite deck of the invention now provides not only for a new group of flush hands, but for the ultimate winning hand of “5 Aces Flush”.

As will be apparent from FIG. 2, by using the composite deck of the invention, the Ace High hand achievable with a conventional 52-card deck becomes a Straight hand.

As will be apparent from FIG. 3, by using the composite deck of the invention, the One Pair hand achievable with a conventional 52-card deck is expanded to two hands; One Flush Pair over One Pair.

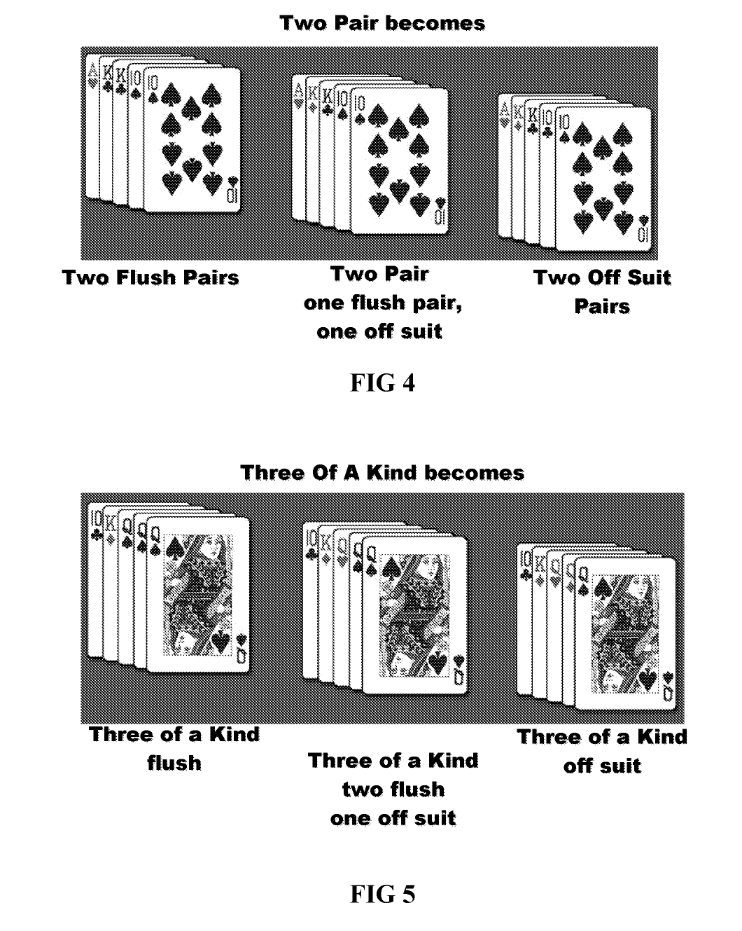

As will be apparent from FIG. 4, by using the composite deck of the invention, the Two Pair hand achievable with a conventional 52-card deck is expanded to three hands; Two Flush Pairs, over Two Pair One Flush One Off Suit over Two Pair.

As will be apparent from FIG. 5, by using the composite deck of the invention, the Three Of A Kind hand achievable with a conventional 52-card deck is expanded to three hands; Three Of A Kind Flush, over Three Of A Kind Two Flush One Off Suit, over Three Of A Kind.

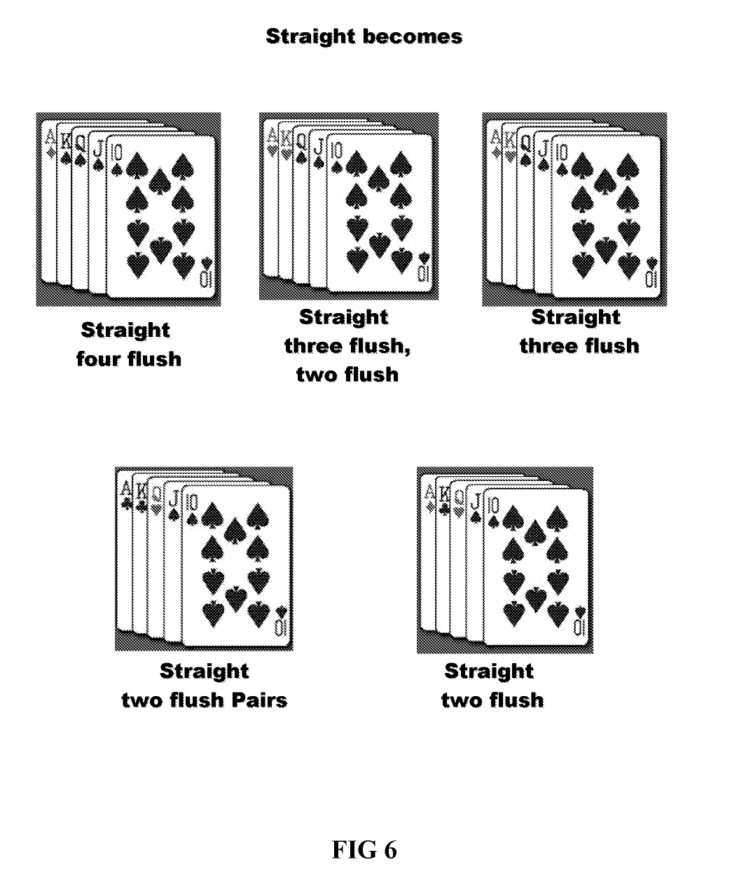

As will be apparent from FIG. 6, by using the composite deck of the invention, the Straight hand achievable with a conventional 52-card deck is expanded to 5 hands; Straight Four Flush, over Straight Three Flush Two Flush, over Straight Three Flush, over Straight Two Flush Pairs, over Straight Two Flush.

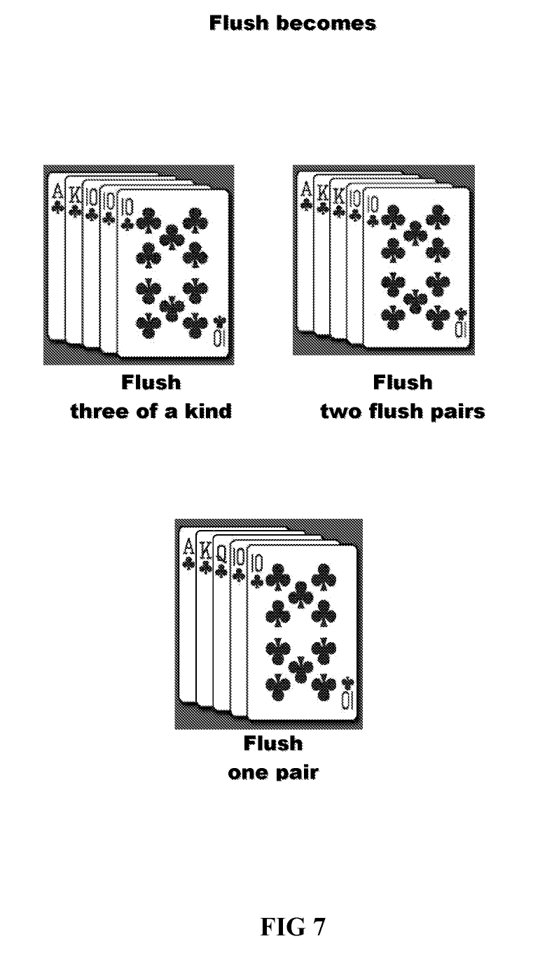

As will be apparent from FIG. 7, by using the composite deck of the invention, the Flush hand achievable with a conventional 52-card deck is expanded to three hands; Flush Three Of A Kind, over Flush Two Pair, over Flush One Pair.

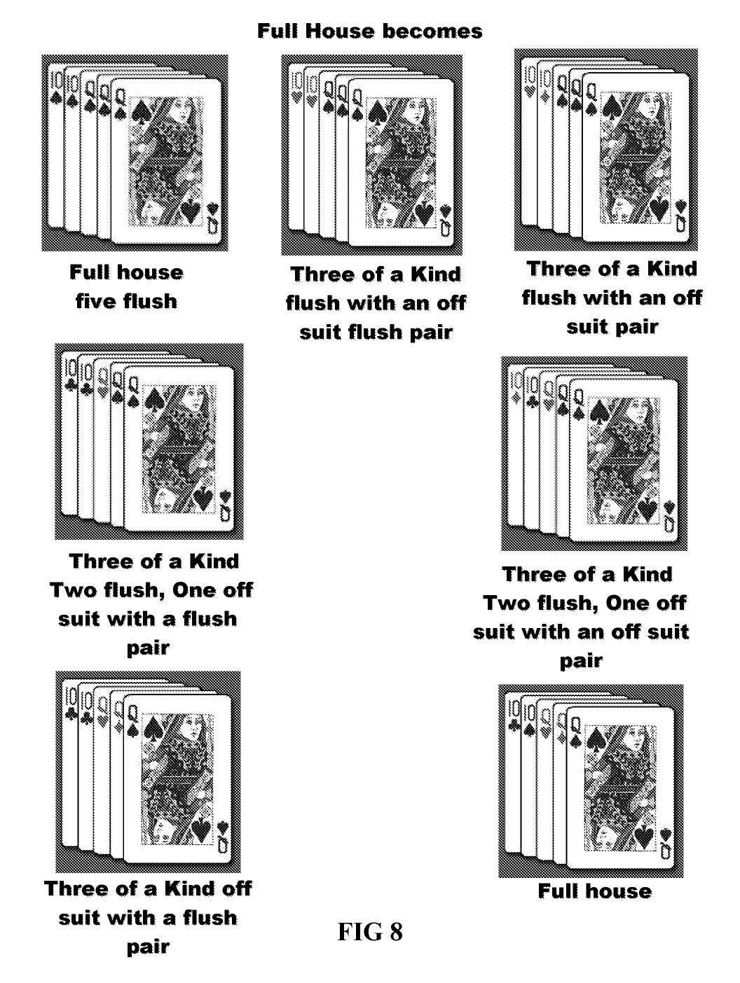

As will be apparent from FIG. 8, by using the composite deck of the invention, the Full House hand achievable with a conventional 52-card deck is expanded to seven hands; Full House Five Flush, over Three Of A Kind Flush With Off Suit Flush Pair, over Three Of A Kind Flush With Off Suit Pair, over Three Of A Kind Two Flush One Off Suit With Flush Pair, over Three Of A Kind Two Flush One Off Suit With Off Suit Pair, over Three Of A Kind Off Suit With Flush Pair, over Full House, all off suit.

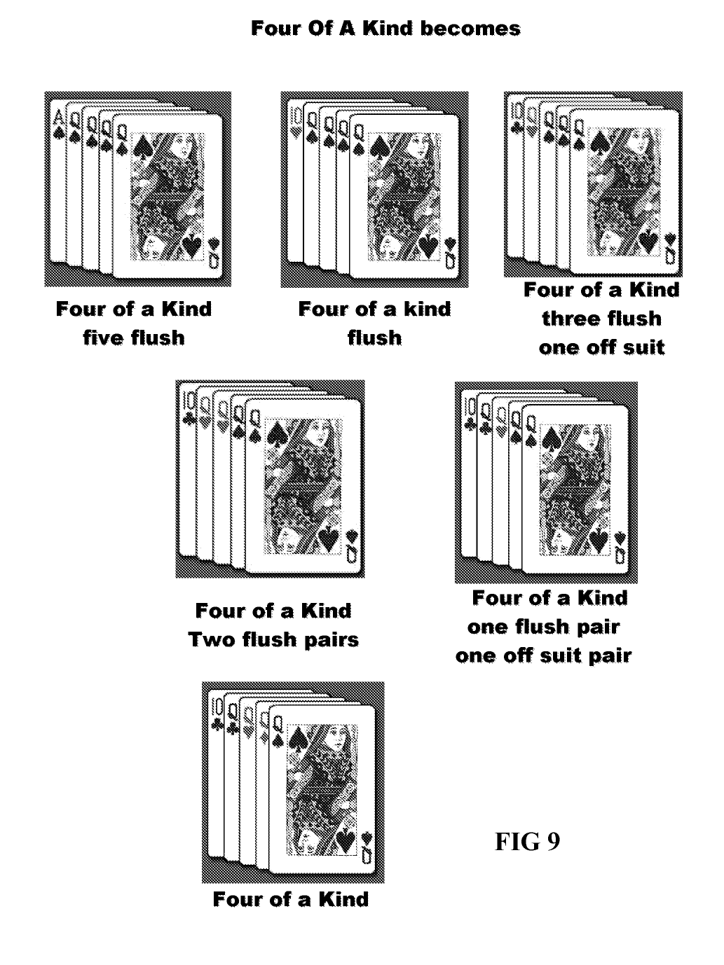

As will be apparent from FIG. 9, by using the composite deck of the invention, the Four Of A Kind hand achievable with a conventional 52-card deck is expanded to six hands; Four Of A Kind Five Flush, over Four Of A Kind Flush, over Four Of A Kind Three

Flush One Off Suit, over Four Of A Kind Two Flush Pair, over Four Of A Kind One Flush Pair One Off Suit Pair, over Four Of A Kind, all off suit.

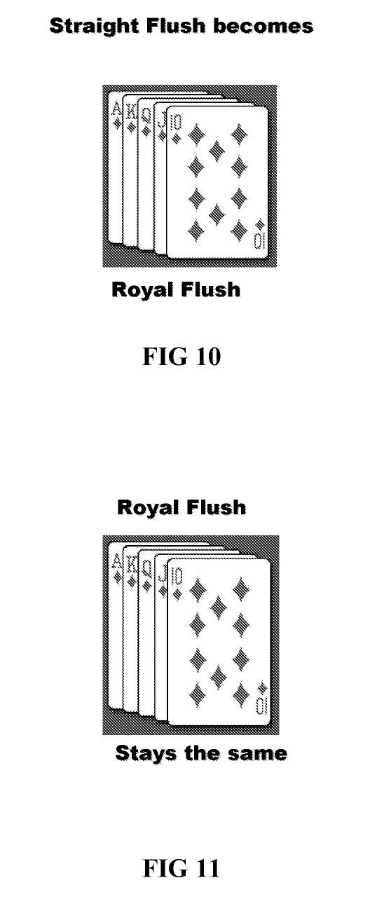

As will be apparent from FIG. 10, by using the composite deck of the invention, the Straight Flush hand achievable with a conventional 52-card deck becomes a Royal Flush hand.

As will be apparent from FIG. 11, by using the composite deck of the invention, the Royal Flush hand achievable with a conventional 52-card deck remains the same with the composite deck of the invention.

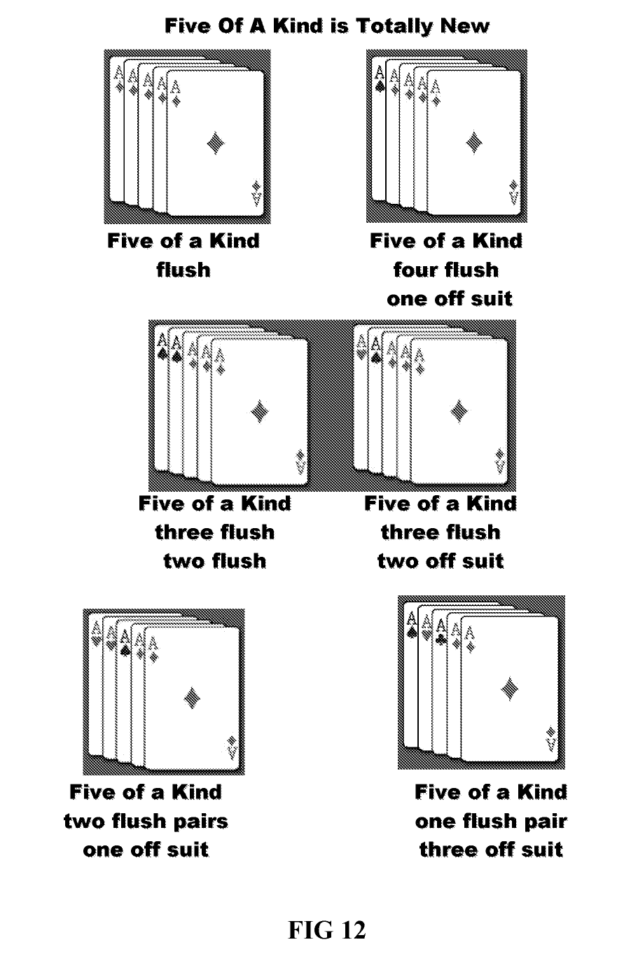

As will be apparent from FIG. 12, the composite deck of the invention provides for a totally new class of winning hands, the Five Of A Kind hands, which are not previously achievable with a conventional 52-card deck. There are 6 winning hands of the Five Of A Kind type; Five Of A Kind Flush, over Five Of A Kind 4 Flush One Off Suit, over Five Of A Kind Three Flush Two Flush, over Five Of A Kind Three Flush Two Off Suit, over Five Of A Kind Two Flush Pairs One Off Suit, over Five Of A Kind One Flush Pair Three Off Suit.

For a better understanding of the unique Poker winning hands obtainable with the composite deck of the invention, the invention in a further aspect provides an illustration, poster or display of at least one of the unique winning hands obtainable with the composite deck of the invention, namely Five Of A Kind Flush, Five Of A Kind 4 Flush One Off Suit, Five Of A Kind Three Flush Two Flush, Five Of A Kind Three Flush Two Off Suit, Five Of A Kind Two Flush Pairs One Off Suit, Five Of A Kind One Flush Pair Three Off Suit, One Flush Pair, Two Flush Pairs, Two Pair One Flush One Off Suit, Three Of A Kind Flush, Three Of A Kind Two Flush One Off Suit, Straight Four Flush, Straight Three Flush Two Flush, Straight Three Flush, Straight Two Flush Pairs, Straight Two Flush, Flush Three Of A Kind, Flush Two Pair, Flush One Pair, Full House Five Flush, Three Of A Kind Flush With Off Suit Flush Pair, Three Of A Kind Flush With Off Suit Pair, Three Of A Kind Two Flush One Off Suit With Flush Pair, Three Of A Kind Two Flush One Off Suit With Off Suit Pair, Three Of A Kind Off Suit With Flush Pair, Four Of A Kind Five Flush, Four Of A Kind Flush, Four Of A Kind Three Flush One Off Suit, Four Of A Kind Two Flush Pair, and Four Of A Kind One Flush Pair One Off Suit Pair.

Preferably, the illustration, poster or display includes at least the top level winning hands of Five Of A Kind, namely Five Of A Kind Flush, Five Of A Kind 4 Flush One Off Suit, Five Of A Kind Three Flush Two Flush, Five Of A Kind Three Flush Two Off Suit, Five Of A Kind Two Flush Pairs One Off Suit, and Five Of A Kind One Flush Pair Three Off Suit.

The composite deck of the invention when used in any of the standard poker variations, such as Draw Poker, Seven-Card Stud, Texas Hold'em, Omaha, Caribbean Poker, Pai Gow Poker, and the like provides yet another advantage over standard decks. It will be much harder to predict possible winning hands. In standard poker variations, especially when a twenty-card deck is used, it is possible for an experienced player to fairly easily calculate the odds of having a winning hand on the basis of the player's cards and the community cards. In contrast, the possible permutations of achieving a winning hand, given certain player cards and community cards, are over two orders of magnitude higher with the new composite deck in accordance with the invention than with a standard deck. Thus, it will be much more difficult to predict the odds of having a winning hand, thus making the game of poker more challenging and exciting.

In one possible poker game, the composite deck of the invention is used in a method including in combination the steps of providing the composite deck consisting of five sets of four differently suited playing cards each having a poker value of a 10; five sets of four differently suited playing cards each having a poker value of a Jack; five sets of four differently suited playing cards each having a poker value of a Queen; five sets of four differently suited playing cards each having a poker value of a King; and five sets of four differently suited playing cards each having a poker value of an Ace; and dealing at least two and up to five cards from the composite deck to each of at least two and at most 46 players to provide each player with at most 5 playing cards each having a poker value ranging from 10 as the lowest value to Ace as the highest value. In a variant of the method, at least one and at most five of the cards in the composite deck is replaced with a Joker card.

In a preferred embodiment, the composite deck of the present invention is used to play Texas Hold'em. However, it should be clearly understood that the deck of the invention can be used with any other type of poker game, whether listed above or not. Particularly, the composite deck of the present invention could be used in any of the standard poker variations in table games as well as those available for play on poker gaming machines, such as video poker, as will be discussed in more detail further below. Representations of the new winning hands of five of a kind can also be used in pinball machines to identify the locations at which the highest possible number of points can be won, as will be discussed in more detail further below.

When using the composite deck of the invention to play Texas Hold'Em, a conventional poker-type card game table is preferably used, having a dealer area, up to nine player hand areas and a discard area. It will of course be readily understood that the high number of cards included in the composite deck of the invention opens up the possibility of having more than nine players participate in a single round. In Texas Hold'em, each player receives 2 cards. With nine players, five community cards and three burn cards, only twenty six cards of the composite deck will be in use, leaving 74 cards un-utilized. This creates the possibility of single playing rounds with a large number of players, all playing with the same composite deck. In an online gaming setup, up to 46 players could theoretically participate before the composite deck is fully utilized (2 player cards, five community cards, three burn cards). Thus, the composite deck of the invention can be very useful for online gaming, since the size of a winning pot will be potentially quite large even for small individual bets.

When the composite deck of the invention is used for playing a Texas Hold'Em poker game, the deck is used in a method including in combination the steps of providing the composite deck consisting of five sets of four differently suited playing cards each having a poker value of a 10; five sets of four differently suited playing cards each having a poker value of a Jack; five sets of four differently suited playing cards each having a poker value of a Queen; five sets of four differently suited playing cards each having a poker value of a King; and five sets of four differently suited playing cards each having a poker value of an Ace; dealing two cards from said composite deck to each of at least 2 and a most 46 players to provide each player with playing cards having a potential poker value ranging from 10 as the lowest value to Ace as the highest value; dealing five community cards face up from the composite deck for use by each player; the five community playing cards being dealt by the steps of burning one card before a three card flop of said five community cards is dealt, burning a second card before a turn card of said five community high valued cards is dealt and burning a third card before a river card of the five community cards is dealt.

In a variant of this method, at least one and at most five of the cards in the composite deck is replaced with a Joker card before any cards are dealt to the players.

In another variant, at least one and at most five of the cards in the composite deck is replaced with a Joker card before the community cards are dealt. Preferably, five cards, respectively of the value 10, Jack, Queen, King and Ace, are replaced by a joker.

The composite card deck of the invention is preferably sold in the form of a commercial package or kit for playing a card game, which kit includes the composite deck of the invention as described above, with or without jokers, and instructions for playing the card game, preferably a poker game, more preferably a poker game as described above.

In a variant of the commercial package or kit, the kit includes instructions for playing a Texas Hold'Em Poker game as described above.

The composite deck of the invention can also be used not only in standard video poker gaming machines, but in video poker gaming machines which involve the new variation of “triple play” video poker, wherein a player is dealt three draw poker hands simultaneously.

When using the composite deck of the invention in association with video poker gaming machines or in online poker gaming setups, bonus awards of a certain predetermined amount could be awarded for added excitement and player engagement to any of the Five Of A Kind winning hands uniquely made possible by use of the composite deck of the invention, namely Five Of A Kind Flush, Five Of A Kind 4 Flush One Off Suit, Five Of A Kind Three Flush Two Flush, Five Of A Kind Three Flush Two Off Suit, Five Of A Kind Two Flush Pairs One Off Suit, and Five Of A Kind One Flush Pair Three Off Suit. A lesser and graduated bonus award could be offered for any other winning hand unique to the composite deck of the invention.

A video poker gaming machine generally includes a processor for creating random poker hands obtainable with a deck of 52 or 20 cards, a display for illustrating the respective poker hand created by the processor, and a pay table including payouts for winning hands. When a video poker gaming machine is used in association with the composite deck of the invention, the processor is programmed to create any hand possible with the composite deck under the poker rules associated with the particular game being played on the machine. Furthermore, the pay includes payouts for at least one winning hand selected from the group of Five Of A Kind Flush, Five Of A Kind 4 Flush One Off Suit, Five Of A Kind Three Flush Two Flush, Five Of A Kind Three Flush Two Off Suit, Five Of A Kind Two Flush Pairs One Off Suit, and Five Of A Kind One Flush Pair Three Off Suit. Preferably, the pay table includes at least one additional payout for at least one winning hand selected from the group of One Flush Pair, Two Flush Pairs, Two Pair One Flush One Off Suit, Three Of A Kind Flush, and Three Of A Kind Two Flush One Off Suit, Straight Four Flush, Straight Three Flush Two Flush, Straight Three Flush, Straight Two Flush Pairs, Straight Two Flush, Flush Three Of A Kind, Flush Two Pair, Flush One Pair, Full House Five Flush, Three Of A Kind Flush With Off Suit Flush Pair, Three Of A Kind Flush With Off Suit Pair, Three Of A Kind Two Flush One Off Suit With Flush Pair, Three Of A Kind Two Flush One Off Suit With Off Suit Pair, Three Of A Kind Off Suit With Flush Pair, Four Of A Kind Five Flush, Four Of A Kind Flush, Four Of A Kind Three Flush One Off Suit, Four Of A Kind Two Flush Pair, Four Of A Kind One Flush Pair One Off Suit Pair.

When operating a conventional video poker gaming machine as described above in association with the composite card deck of the invention, operation of the machine preferably includes the steps of providing a pay table with at least one and up to six top level bonus amounts, and each top level bonus amount being assigned to a different winning hand selected from the group of Five Of A Kind Flush, Five Of A Kind 4 Flush One Off Suit, Five Of A Kind Three Flush Two Flush, Five Of A Kind Three Flush Two Off Suit, Five Of A Kind Two Flush Pairs One Off Suit, and Five Of A Kind One Flush Pair Three Off Suit.

In a variant of the video poker gaming machine operation as described above, the operation of the machine includes the further steps of including in the pay table at least one secondary bonus amount of lesser value than the top level bonus amounts and assigning the secondary bonus amount to at least one hand selected from the group of One Flush Pair, Two Flush Pairs, Two Pair One Flush One Off Suit, Three Of A Kind Flush, Three Of A Kind Two Flush One Off Suit, Straight Four Flush, Straight Three Flush Two Flush, Straight Three Flush, Straight Two Flush Pairs, Straight Two Flush, Flush Three Of A Kind, Flush Two Pair, Flush One Pair, Full House Five Flush, Three Of A Kind Flush With Off Suit Flush Pair, Three Of A Kind Flush With Off Suit Pair, Three Of A Kind Two Flush One Off Suit With Flush Pair, Three Of A Kind Two Flush One Off Suit With Off Suit Pair, Three Of A Kind Off Suit With Flush Pair, Four Of A Kind Five Flush, Four Of A Kind Flush, Four Of A Kind Three Flush One Off Suit, Four Of A Kind Two Flush Pair, and Four Of A Kind One Flush Pair One Off Suit Pair. Preferably, the pay table includes at least 24 graduated secondary bonus amounts of lesser value than the top level bonus amounts, each secondary bonus amount being assigned to a different winning hand selected from the group of One Flush Pair, Two Flush Pairs, Two Pair One Flush One Off Suit, Three Of A Kind Flush, Three Of A Kind Two Flush One Off Suit, Straight Four Flush, Straight Three Flush Two Flush, Straight Three Flush, Straight Two Flush Pairs, Straight Two Flush, Flush Three Of A Kind, Flush Two Pair, Flush One Pair, Full House Five Flush, Three Of A Kind Flush With Off Suit Flush Pair, Three Of A Kind Flush With Off Suit Pair, Three Of A Kind Two Flush One Off Suit With Flush Pair, Three Of A Kind Two Flush One Off Suit With Off Suit Pair, Three Of A Kind Off Suit With Flush Pair, Four Of A Kind Five Flush, Four Of A Kind Flush, Four Of A Kind Three Flush One Off Suit, Four Of A Kind Two Flush Pair, and Four Of A Kind One Flush Pair One Off Suit Pair.

Winning Poker hands are sometimes used on pinball machines, which include a playing field and scoring elements on the playing field representing different amounts of winning points, wherein at least one of the scoring elements is labeled on the playing field by a representation of a winning Poker hand. Conventional pinball machines can now be modified for use with the composite card deck in accordance with the invention and, more specifically, one or more of the unique winning hands possible with the card deck of the invention. In a preferred pinball machine in accordance with one aspect of the invention, at least one of the scoring elements is labeled with at least one hand selected from the group of Five Of A Kind Flush, Five Of A Kind 4 Flush One Off Suit, Five Of A Kind Three Flush Two Flush, Five Of A Kind Three Flush Two Off Suit, Five Of A Kind Two Flush Pairs One Off Suit, and Five Of A Kind One Flush Pair Three Off Suit. Preferably, the scoring element representing the highest amount of winning points is labeled on the playing field with the hand of Five Of A Kind Flush.

In another aspect, the invention provides a pinball machine with multiple scoring elements, each scoring elements being labeled with at least one of the winning hands of Five Of A Kind Flush, Five Of A Kind 4 Flush One Off Suit, Five Of A Kind Three Flush Two Flush, Five Of A Kind Three Flush Two Off Suit, Five Of A Kind Two Flush Pairs One Off Suit, and Five Of A Kind One Flush Pair Three Off Suit, One Flush Pair, Two Flush Pairs, Two Pair One Flush One Off Suit, Three Of A Kind Flush, Three Of A Kind Two Flush One Off Suit, Straight Four Flush, Straight Three Flush Two Flush, Straight Three Flush, Straight Two Flush Pairs, Straight Two Flush, Flush Three Of A Kind, Flush Two Pair, Flush One Pair, Full House Five Flush, Three Of A Kind Flush With Off Suit Flush Pair, Three Of A Kind Flush With Off Suit Pair, Three Of A Kind Two Flush One Off Suit With Flush Pair, Three Of A Kind Two Flush One Off Suit With Off Suit Pair, Three Of A Kind Off Suit With Flush Pair, Four Of A Kind Five Flush, Four Of A Kind Flush, Four Of A Kind Three Flush One Off Suit, Four Of A Kind Two Flush Pair, and Four Of A Kind One Flush Pair One Off Suit Pair.

The above-described embodiments are intended to be examples only. Alterations, modifications and variations can be effected to the particular embodiments by those of skill in the art without departing from the scope, which is defined solely by the claims appended hereto.

What is claimed is:

1. A composite deck of playing cards, comprising
five sets of four differently suited playing cards each having a value of a 10;
five sets of four differently suited playing cards each having a value of a Jack;
five sets of four differently suited playing cards each having a value of a Queen;
five sets of four differently suited playing cards each having a value of a King; and
five sets of four differently suited playing cards each having a value of an Ace.

2. The composite deck of claim 1, wherein each twenty-card set includes the cards of 10, Jack, Queen, King and Ace in each of the four suits of Diamonds, Clubs, Hearts and Spades.

3. The composite deck of claim 1, wherein at least one and at most five cards in the composite deck are replaced by a Joker card.

4. The composite deck of claim 3, wherein 5 cards are replaced with the values of 10, Jack, Queen, King and Ace.

5. A method of playing a poker game, comprising in combination the steps of providing a composite deck consisting of five
five sets of four differently suited playing cards each having a poker value of a 10;
five sets of four differently suited playing cards each having a poker value of a Jack;
five sets of four differently suited playing cards each having a poker value of a Queen;
five sets of four differently suited playing cards each having a poker value of a King; and
five sets of four differently suited playing cards each having a poker value of an Ace; and
dealing at least two and up to five cards from said composite deck to each of at least two and at most 46 players to provide each player with at most 5 playing cards each having a poker value ranging from 10 as the lowest value to Ace as the highest value.

6. The method of claim 5, wherein at least one and at most five of the cards in the composite deck is replaced with a Joker card.

7. The method of claim 6, wherein 5 cards with the values of 10, Jack, Queen, King and Ace are replaced by the joker.

8. A method of playing a Texas Hold'Em poker game comprising in combination the steps of
providing a composite deck consisting of five sets of four differently suited playing cards each having a poker value of a 10;
five sets of four differently suited playing cards each having a poker value of a Jack;
five sets of four differently suited playing cards each having a poker value of a Queen;
five sets of four differently suited playing cards each having a poker value of a King; and
five sets of four differently suited playing cards each having a poker value of an Ace;
dealing two hole cards from said composite deck to each of at least 2 and a most 46 players;
dealing five community cards face up from the composite deck for use by each player;
said five community playing cards being dealt by the steps of burning one card before a three card flop of said five community cards is dealt, burning a second card before a turn card of said five community high valued cards is dealt and burning a third card before a river card of said five community cards is dealt.

9. The method of claim 6, wherein at least one and at most five of the cards in the composite deck is replaced with a Joker card before the community cards are dealt.

10. The method of claim 6, wherein 5 cards are replaced with the values of 10, Jack, Queen, King and Ace.

11. A kit for playing a card game, comprising the composite deck of claim 1, and instructions for playing the card game.

12. The kit of claim 9, wherein the card game is a poker game.

13. The kit of claim 10, wherein the poker game is played according to the method of one of claim 5.

14. A kit for playing a Texas Hold'Em Poker game, comprising the composite deck of claim 1, and instructions for playing the game of claim 8.

15. A pinball machine comprising a playing field and scoring elements on the playing field representing different amounts of winning points, wherein at least one of the scoring elements is labeled on the playing field by a representation of a winning Poker hand selected from the group of Five Of A Kind Flush, Five Of A Kind 4 Flush One Off Suit, Five Of A Kind Three Flush Two Flush, Five Of A Kind Three Flush Two Off Suit, Five Of A Kind Two Flush Pairs One Off Suit, and Five Of A Kind One Flush Pair Three Off Suit.

16. The pinball machine of claim 16, wherein the scoring element representing the highest amount of winning points is labeled on the playing field with the hand of Five Of A Kind Flush.

17. A video poker gaming machine, comprising a processor for creating random poker hands obtainable with a deck of cards according to claim 1, a display for illustrating a respective poker hand created by the processor and a pay table including payouts for at least one winning hand selected from the group of Five Of A Kind Flush, Five Of A Kind 4 Flush One Off Suit, Five Of A Kind Three Flush Two Flush, Five Of A Kind Three Flush Two Off Suit, Five Of A Kind Two Flush Pairs One Off Suit, and Five Of A Kind One Flush Pair Three Off Suit.

18. The video poker gaming machine of claim 18, wherein the pay table includes at least one additional payout for at least one winning hand selected from the group of One Flush Pair, Two Flush Pairs, Two Pair One Flush One Off Suit, Three Of A Kind Flush, and Three Of A Kind Two Flush One Off Suit, Straight Four Flush, Straight Three Flush Two Flush, Straight Three Flush, Straight Two Flush Pairs, Straight Two Flush, Flush Three Of A Kind, Flush Two Pair, Flush One Pair, Full House Five Flush, Three Of A Kind Flush With Off Suit Flush Pair, Three Of A Kind Flush With Off Suit Pair, Three Of A Kind Two Flush One Off Suit With Flush Pair, Three Of A Kind Two Flush One Off Suit With Off Suit Pair, Three Of A Kind Off Suit With Flush Pair, Four Of A Kind Five Flush, Four Of A Kind Flush, Four Of A Kind Three Flush One Off Suit, Four Of A Kind Two Flush Pair, Four Of A Kind One Flush Pair One Off Suit Pair.

19. A method of operating a video poker gaming machine, including the steps of providing a pay table with six top level bonus amounts, and assigning each top level bonus amount to a different winning hand selected from the group of Five Of A Kind Flush, Five Of A Kind 4 Flush One Off Suit, Five Of A Kind Three Flush Two Flush, Five Of A Kind Three Flush Two Off Suit, Five Of A Kind Two Flush Pairs One Off Suit, and Five Of A Kind One Flush Pair Three Off Suit.

20. The method of claim 20, comprising the further steps of including in the pay table at least one secondary bonus amount of lesser value than the top level bonus amounts and assigning the secondary bonus amount to at least one hand selected from the group of One Flush Pair, Two Flush Pairs, Two Pair One Flush One Off Suit, Three Of A Kind Flush, Three Of A Kind Two Flush One Off Suit, Straight Four Flush, Straight Three Flush Two Flush, Straight Three Flush, Straight Two Flush Pairs, Straight Two Flush, Flush Three Of A Kind, Flush Two Pair, Flush One Pair, Full House Five Flush, Three Of A Kind Flush With Off Suit Flush Pair, Three Of A Kind Flush With Off Suit Pair, Three Of A Kind Two Flush One Off Suit With Flush Pair, Three Of A Kind Two Flush One Off Suit With Off Suit Pair, Three Of A Kind Off Suit With Flush Pair, Four Of A Kind Five Flush, Four Of A Kind Flush, Four Of A Kind Three Flush One Off Suit, Four Of A Kind Two Flush Pair, and Four Of A Kind One Flush Pair One Off Suit Pair.

21. The method of claim 20, comprising the further steps of including in the pay table at least 24 graduated secondary bonus amounts of lesser value than the top level bonus amounts and assigning each secondary bonus amount to a different winning hand selected from the group of One Flush Pair, Two Flush Pairs, Two Pair One Flush One Off Suit, Three Of A Kind Flush, Three Of A Kind Two Flush One Off Suit, Straight Four Flush, Straight Three Flush Two Flush, Straight Three Flush, Straight Two Flush Pairs, Straight Two Flush, Flush Three Of A Kind, Flush Two Pair, Flush One Pair, Full House Five Flush, Three Of A Kind Flush With Off Suit Flush Pair, Three Of A Kind Flush With Off Suit Pair, Three Of A Kind Two Flush One Off Suit With Flush Pair, Three Of A Kind Two Flush One Off Suit With Off Suit Pair, Three Of A Kind Off Suit With Flush Pair, Four Of A Kind Five Flush, Four Of A Kind Flush, Four Of A Kind Three Flush One Off Suit, Four Of A Kind Two Flush Pair, and Four Of A Kind One Flush Pair One Off Suit Pair.

22. An illustration, poster or display, comprising an illustration surface and on the illustration surface representations of at least one winning hand obtainable with the composite set of cards of claim 1.

23. The illustration, poster or display according to claim 23, wherein the representations are of the winning hands of Five Of A Kind, namely Five Of A Kind Flush, Five Of A Kind 4 Flush One Off Suit, Five Of A Kind Three Flush Two Flush, Five Of A Kind Three Flush Two Off Suit, Five Of A Kind Two Flush Pairs One Off Suit, and Five Of A Kind One Flush Pair Three Off Suit.

24. The illustration, poster or display according to claim 23, wherein the representations are of the winning hands of Five Of A Kind, namely Five Of A Kind Flush, Five Of A Kind 4 Flush One Off Suit, Five Of A Kind Three Flush Two Flush, Five Of A Kind Three Flush Two Off Suit, Five Of A Kind Two Flush Pairs One Off Suit, Five Of A Kind One Flush Pair Three Off Suit, One Flush Pair, Two Flush Pairs, Two Pair One Flush One Off Suit, Three Of A Kind Flush, Three Of A Kind Two Flush One Off Suit, Straight Four Flush, Straight Three Flush Two Flush, Straight Three Flush, Straight Two Flush Pairs, Straight Two Flush, Flush Three Of A Kind, Flush Two Pair, Flush One Pair, Full House Five Flush, Three Of A Kind Flush With Off Suit Flush Pair, Three Of A Kind Flush With Off Suit Pair, Three Of A Kind Two Flush One Off Suit With Flush Pair, Three Of A Kind Two Flush One Off Suit With Off Suit Pair, Three Of A Kind Off Suit With Flush Pair, Four Of A Kind Five Flush, Four Of A Kind Flush, Four Of A Kind Three Flush One Off Suit, Four Of A Kind Two Flush Pair, and Four Of A Kind One Flush Pair One Off Suit Pair.
